(19) United States
(12) Patent Application Publication
(10) Pub. No.: US 2002/0104027 A1
(43) Pub. Date: Aug. 1, 2002

(54) N-dimensional biometric security system

(76) Inventor: Valene Skerpac, Cro ton-On-Hudson, NY (US)

Correspondence Address: Francis C. Hand, Esq., c/o Carella, Byme, Bain, Gilfillan, Cecchi,, Stewart & Olstein, 6 Becker Farm Road, Roseland, NJ, 07068, US

(21) Appl. No.: 10/062,799

(22) Filed: Jan. 31, 2002

Related U.S. Application Data
(60) Provisional application No. 60/265,266, filed on Jan. 31, 2001.

(51) Int. Cl. H04L 9/32

(52) U.S. Cl. 713/202

(57) ABSTRACT

A security system and method are provided that relies, in one embodiment, on speech recognition to not only identify but also to validate a user. In use, the system requires a user to initially input information representative of the user at a station. A responsive signal is then generated and validated as representative of the user. Thereafter, a randomly generated challenge phrase appears at the station for the user to speak in response to validation of generated signal. The user then speaks the randomly generated challenge phrase and generates a second signal representative of the spoken response to the challenge phrase. This second signal is then processed for determining what was actually spoken as well as for the voice characteristics of the speaking voice. If a match is made for the two parameters, identification and validation of the user is complete and access is given. Changing the challenge phrase in a randomly generated manner reduces the possibility of an intruder impersonating the voice of a true user.

This application claims the benefit of Provisional Patent Application 60/265,266 filed Jan. 31, 2001.

### BACKGROUND

User authentication is a critical aspect of information systems security. Protection from unauthorized user access or actions is essential to the confidentiality, integrity and availability of data, systems and networks. Biometric access control security systems have been developed to provide such protection by allowing authorized access only to authenticated users who pass a biometric identification or verification test. Biometric security systems implemented to date are mostly one-dimensional systems that use a biometric like a tag; a system where there is one biometric associated with one person such as a fingerprint. If implemented securely, one-dimensional biometric security systems can improve security greatly over password systems and are simple to use but are subject to privacy concerns, theft fears and big-brother trepidation.

One-dimensional biometric security system implementations force the user to rely completely on an underlying unknown security system to insure the biometric is authentic and depend on system administration to insure privacy. On the other hand, an n-dimensional biometric system, which tightly couples a dynamic biometric with human input, can vary n times. Aspects of human user control and management can now be incorporated in the authentication process. Intricate knowledge of the dynamic biometric by unauthorized persons does not mean that the biometric can no longer be used because each instance of the biometric authentication is unique to the session. One example of such a system is a speaker recognition system coupled with the many combinations of language using speech recognition. Another example is a tightly coupled signature and handwriting recognition system, which similarly utilizes language variations. An n-dimensional biometric security system can be implemented so that robust security techniques and intuitive privacy schemes are realized which relieves privacy concerns, fears of biometric theft and trepidation of big-brother control.

The present invention provides an n-dimensional biometric security system architecture that extends the capabilities of today's primarily one dimensional biometric security systems so that concerns and fears can be addressed. The proposed system simultaneously yet independently uses biometric speaker recognition and real-time natural language processing whereby one practical implementation is proposed based on an improved voice architecture in a data communications environment.

One of the biggest security exposures today is unauthorized user access to data, systems and networks. Biometric security systems have been developed to address such an exposure by allowing authorized access only to users who pass a biometric identification or verification test. The underpinnings of identification and verification systems analyze a users biometrics input, create a compressed statistical form or template and match the template to statistical information previously stored upon enrollment [1]. Variations in biometrics input, algorithms and matching techniques exist which effect accuracy and usability of the biometric.

Another way to view the proposed system is to draw out the qualities of a privately secured biometric system and characterize it as one that gives the user the capability to re-establish their biometric, given their identity is confirmed, and allows the user intuitive private control and understanding of their own biometric. In the information systems security community we define biometrics as ‘Something you are’ that can be used for identification and authentication purposes and thereby has particular value when used as a counter measure against computer security exposures [2]. This invention extends the use of ‘Something you are’ to be applicable to agreed upon time periods, user and organizational discretion.

The proposed scheme improves security through a robust challenge response method of randomly generated phrases whereby the user must pass speaker recognition and voice recognition tests simultaneously. The scheme further improves security and privacy through the use of language sets and an optional user challenge response method whereby the user must pass verification and recognition tests simultaneously of a user selected phrase. The use of language and language sets gives the user an intuitive understanding of the biometric security system and control over his or her participation with the system. The proposed n-dimensional biometric security system enables a user to establish a biometric identity for a certain period of time or purpose allaying fears and providing a powerful tool for organizations and users to address security and privacy issues. The system is practical for information systems today and is envisioned to be most effective and applicable in a data communications environment particularly where voice processing is prevalent. The following describes the security architecture and applies it to a system implementation architecture that utilizes the power of a master processor for security and database functions, the quality of voice processors at intelligent remote unit sites such as desktop, hand held device, mobile phone, voice over IP phone (VoIP) and/or their associated local servers/PBXs and the most appropriate encryption method(s).

One goal of the n-dimensional security system is that it can provide for security and privacy as agreed to by the user. Examples of potential uses of the system are an ISP service, which performs network and application authentication services across multi-media platforms for access to many applications such as email, messaging, and others. Remote users in a speaking environment could include speaker verification for ISP network and application authentication from different devices intelligently consolidated and controlled by the n-dimensional system proposed.

A further example is that of a specialized application where the user wishes to view his or her private data that resides in an application hosted by an Application Service Provider (ASP). At some point in time, the user may want to move his or her private information to another application provider. The n-dimensional system allows the user to be deleted from the “History language set” at their previous ASP and enrolled in the “Art language set” at their new ASP. A second example is that of a consultant who is temporarily working with an organization and needs access to corporate systems. The organization would like to remove the consultant from the system upon contract termination and likewise, the consultant wants to be assured that the biometric is no longer useful.

It is assumed that today's example of a practical application uses biometric verification versus identification technology because identification requires more resources and verification is adequate for many applications today including the examples discussed above. Secondly, it is assumed that the sample voice system described herein uses 1,000 random phrases in each language set and that each language set has the same specifications and characteristics. Given these assumptions, if we try to use verification schemes presented in the past, the following shortcomings become apparent:

One predominant scheme, referred to as one-dimensional, is where the system performs matches on a particular biometrics template derived from a particular eye, finger or head position. If there is a match, the user is positively authenticated. One finger narrows the scope of biometrics capture, compression and the matching process making it easier to identify the user through the biometric and simple for the user. Since this kind of system uses a static biometric, i.e. one that does not change easily, then the system cannot meet certain security and privacy requirements because the fingerprint can be obtained by someone else and the user cannot change or has no other option associated with his or her fingerprint. In this case, there is one dimension according to the proposed model whereas each language set of 1,000 phrases has 1,000 options or dimensions. Other measures beyond the biometric must be taken to insure the biometric is authentic and privacy entrusted.

A second approach is to perform a match on a particular biometrics template derived from any phrase or head position with no other associated controls. If there is a match, the user is positively authenticated. This method frees the user of constraints and provides great freedom of choice but is not as secure since there is little control of what the user may say or how he or she may turn. This scheme easily leads to situations of a one-phrase voice password as chosen by the user or inadequate biometric samples. A one-phrase password has the same shortcomings as the one dimensional biometric discussed previously. Inadequate biometric samples diminish the accuracy of the authentication process significantly and are not represented by the model.

Another approach is a small set of biometrics variations like a multiple fingerprint system or a small set multi-phrase system where voice verification and recognition are tightly coupled non-independent processes. These types of systems typically represent variations or dimensions of less than fifty with no options remaining once exhausted. While a small set offers more security than a one-dimensional system because the biometric required for access is harder to anticipate and offers more privacy options, the system soon runs out of options which falls short of an n-dimensional security system. Of significance as well is that when voice verification and recognition are tightly coupled in non-independent processes the process tends to be rigid and behaviorally oriented. This is limiting since people are prone to not saying things exactly the same each time they speak. The proposed n-dimensional system gets around this problem with the simultaneous yet independent speaker and speech recognition processes.

There also exists a security scheme that uses speaker recognition along with verbal information verification where the user provides information, which contains private information that supposedly only he or she knows [3]. This is not as secure or private for the applications intended because the user has to supply and say aloud his or her private information, which could be overheard.

Accordingly, it is the object of the proposed n-dimensional biometrics security system to overcome the security system shortcomings summarized above. The n-dimensional biometric solution is a security scheme that can be effectively implemented today with the implementation of simultaneous yet independent speaker recognition and speech recognition processes.

Briefly, the invention provides a n-dimensional biometric security system as well as a method of identifying and validating a user.

The system and method provide a simple technique for identifying a person, for example, a user attempting to gain access to a bank account at an ATM or over the internet, a user attempting to gain access through a door or passageway to a secured area, a user attempting to gain access to a system via a telephone or the like.

The N-dimensional biometric security system comprises a station for receiving input information from a user representative of the user and generating a responsive signal thereto; a first data base having a plurality of words and language rules for generating one-time challenge phrases corresponding to the user and a session access request therein; a second data base having biometric models of the users therein; and a controller communicating with the station to receive and validate the signal as representative of the user. The controller also communicates with the first data base for delivering a randomly generated challenge phrase at the station for the user to speak in response to validation of said signal. The controller further communicates with the station to receive and validate a spoken response to the selected challenge phrase as representative of the user.

The method of identifying and validating a user comprising the steps of having a user initially input information representative of the user at a station; generating a signal responsive to the information; receiving and validating the signal as representative of the user; thereafter delivering a randomly generated challenge phrase at the station for the user to speak in response to validation of the signal; having the user speak the randomly generated challenge phrase and generating a second signal representative of the spoken response to the challenge phrase; and thereafter receiving and validating the second signal as representative of the user.

These and other objects and advantages of the invention will become more apparent from the following detailed description taken in conjunction with the accompanying drawings wherein:

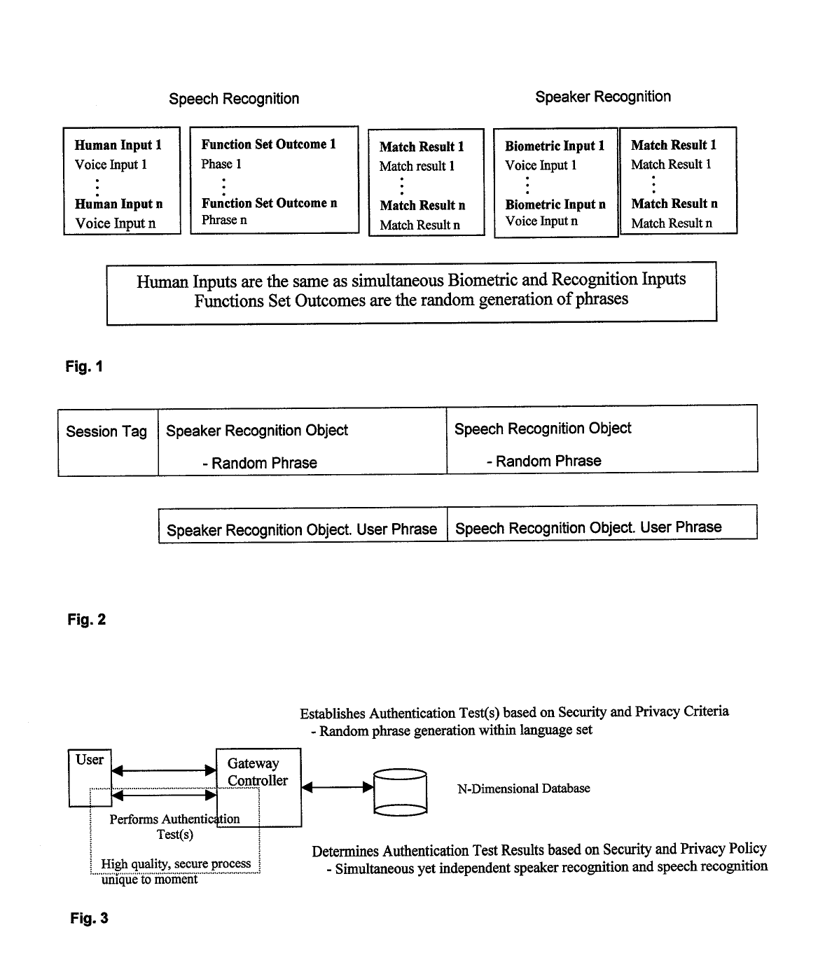

FIG. 1 represents a model of the n-dimensional biometrics access control system using speech in accordance with the invention;

FIG. 2 illustrates a simultaneous record prior to matching whereby a unique date/time identifier and hash of the entire record is imbedded in each object; and

FIG. 3 illustrates a schematic view of the n-dimensional biometrics access control system.

The proposed security scheme improves security over past methods through a system challenge response method of randomly generated phrases. Each time the user is authenticated, a random biometric identifier is created unique to the user at that distinct moment. Upon access, a distinct and random biometric tied uniquely to the user provides the basis for a highly secure system. This prevents an unauthorized user from utilizing the traditional hacking techniques of cracking, stealing information and system penetration with access information at another time. Recording or theft of voice samples or properties do not help a hacker because it would be highly unlikely to reconstruct the random phrase on the fly given the short period of time for which the user and user terminal must respond. The methodology also prevents an “authorized agency” from sending around authentication information that could be used by other third parties without the user directly knowing. The solution addresses security fraud issues that surround token methods such as with Microsoft's passport authentication and authorization system.

The proposed n-dimensional security scheme improves privacy in several ways. One way is through the choice of user phrase selection. This gives the user some control over the authentication process with the option of changing their own phrase or phrases at some future point in time. As long as we combine authentication information from the user selected phrase with authentication information from the random phrase, the security described above will be maintained because the overall biometric identifier remains random and distinct to a moment whereby the user terminal must verify adequate samples.

A second way in which the proposed n-dimensional security scheme improves privacy is through the use of language sets. Language sets are subsets that apply to the same rules and knowledge of the overall language but encompass a subject area that gives the user an intuitive understanding of the system and some control over his or her participation with the system. Because the phrases are generated within a language set there must be enough variation of words, types of words and types of phrase structures to generate the kind of randomness and security required. Language sets give the user and the organization the option of moving users to different language sets or deleting them from the language set forever. It is likely that a user will remember having been in the “Fashion” or “Sports” language set many years down the road since it is so intuitive. This addresses public concerns such as Microsoft's passport token which users distrust and cannot easily and intuitively control.

Language sets are also a good tool for organizations to implement controls associated with their policies improving overall security. On an on-going basis organizations can avoid the difficulty of many Ids and passwords that users find non-intuitive. When employees or third parties leave the organization, a user and its associated biometric information can be deleted unlike other authentication methods that require the organization to keep track of past authentication information. Given the random design of an n-dimensional biometric security system, there is significantly reduced exposure to unauthorized access even if the biometric information were available. If the user or organization believes the biometric information has been compromised or damaged they can change language sets and/or re-enroll. Such techniques alleviate fears of theft and reduce privacy concerns and trepidation over big brother controls. After all, you can't make users say what they don't want to.

For the purpose of demonstration of n-dimensional methods, the scheme is implemented based on the proposed voice architecture. Voice architectures of the past are designed for implementations using either telephone speech over telephone links from any telephone or voice applications such as speech-to-text at a dedicated PC. Telephone speech is geared for a noisy narrow channel reducing voice quality and accuracy. On the other hand, local PC voice implementations utilize a substantially wider channel to perform extensive speech recognition applications. Such local systems are closely tied to the local processor and database, which reduces portability of these voice applications. The proposed voice architecture essentially splits the voice processing so that high quality signal processing and vector processing is performed locally to optimize the wide clear channel for higher accuracy and the majority of matching is performed at the server where a high degree of control and security can be obtained. This proposed architecture therefore meets the needs of the private biometric security network system requiring high accuracy, security and control.

As explained previously, the n-dimensional private biometric system combines speaker and speech technologies a new way. Specifically, once a user requests access, the system controller challenges him to speak a randomly generated phrase and secondly prompts him for a user-determined phrase if he so desires. The objective of the authentication process is to obtain quality speech input, perform high quality signal processing and create the representative statistical forms of both the voice information used for speaker recognition and voice information used for speech recognition for each phrase. This information will be used only in memory at the remote or local unit, combined into one date and time stamped record, encrypted and optionally, digitally signed prior to communication with the controller assuming the controller is resident on another machine. The controller verifies the optional signature and decrypts the information in memory, models and matches against information stored in the n-dimensional database. Authentication is considered successful if both matching results are successful.

Methods of secure design beyond the scope of this application are required to validate the integrity of the design claims specified above. Security techniques at the remote or local unit must be used to insure the integrity of the unique record. Methods to flush memory buffers of latent information upon successful as well as error processes are required. Techniques to validate input channels are needed to insure the reliability of the input source. Communication security techniques of encryption beyond the scope of this application are assumed to be securely designed and implemented with strong algorithms, key management, network protocols, trusted routing and error processing amongst others. It is noted however that specific key creation schemes could be directly tied to the random generator described herein. Security techniques to provide non-repudiation are to be implemented securely. Similarly, security techniques at the controller must be used to insure the integrity, confidentiality and reliability of the n-dimensional engine and database(s) to prevent exposures to the database, buffers, system resources and availability, and the like.

### Simultaneous Verification and Recognition

The intention of the proposed security system is to make use of dynamic biometrics, i.e. biometrics input that can vary, to implement a security system that is n-dimensionally secure. To obtain n-dimensional security, the system establishes a unique biometric identifier for a user at a particular moment in time by obtaining biometric input that can be correlated simultaneously to a prescribed human input by the same user.

The system envisions a dynamic biometrics security system whereby the n-dimensional concept using voice processing is modeled. Human Input N and Biometric Input N are simultaneous. Both match results must independently be positive to authenticate the user positively.

FIG. 1 represents a model of the n-dimensional idea at the concept level using speech. The assumption is that Human Input x which in this case is the vocalization of Phrase x, is equal to Biometric Input x. The biometric matching process result and human recognition matching process results are therefore inexplicably tied. It is the union of Human and Biometric processes versus either performed separately that is the essence of the model and the basis for the benefits of an n dimensional model.

The proposed security scheme uses this model as a basis for the system generated, as well as user generated, phrases. The objective of a practical system today is that the system generates random phrases where n goes minimally to 1,000 phrases and the user chooses phrases where n likely goes from 0 to 5 depending on user preference. A hacker would have great difficulty recreating one of the possible 1,000 phrases on the fly as the security system design is constructed herein. This application discusses the use of language, language sets and practical examples but does not address the vast subject encompassing the natural language processing possibilities inherent in the function sets referred to in FIG. 1. The full potential of these function sets are beyond the scope of the application and represent further areas that refine such a security technique.

As described in the introduction, the objective of the authentication process is to obtain quality speech input, perform high quality input signal processing and create the representative statistical forms of both the voice information used for speaker recognition and voice information used for speech recognition for each phrase. Such speech representations are generated by the algorithms and processing of the biometric processor and natural language processor. Speaker authentication algorithms and processing are one-way and therefore it is not possible to reconstruct the speech input. The design does not allow for recorded or low quality speech.

The human and biometric instance is illustrated in FIG. 2 and further described below.

Once the user requests access, the controller establishes a unique session tag to keep track of the session including a session time out limit. Once the simultaneous input, signal processing and independent speaker and speech recognition modeling or compression are complete for that distinct session, a simultaneous record is constructed in memory before encryption. To additionally insure all objects are bound together we imbed the same unique date/time stamp identifier in each object. To additionally insure that the objects have not been altered or damaged a hash version of the simultaneous record is embedded into each object.

### Phrases and Language Sets

Phrases and Language sets focus on the word or voice recognition aspects of the proposed solution. One can view the scientific study of human language, linguistics, as consisting of phonetics or the physical nature of speech, Phonology or the use of sounds in language, Morphology or word formation, Syntax or sentence structure and Semantics or the meaning of words and how they combine into sentences [4]. Using each area of study one can construct language in written or verbal form whereby the language exists within a language set and meets security and usability requirements. A linguistic scheme is presented that meets the criteria specified below as an example that is practical and can make use of natural language processing available today. There can be many more combinations and uses of linguistics, sounds, visuals or other human interface aspects to obtain higher levels of security should that be desired in the future.

The user requests system access and the n-dimensional biometric system controller respond with a challenge phrase. The controller determines a phrase and requests that the user speak it. Template generation and simultaneous matching as described previously is performed for both phrases. Controller determined phrase(s) allow for management of phrases by the intelligent controller to satisfy security and privacy requirements. Secondly, a user can also be requested to speak a phrase determined by the user. User determined phrase(s) allow management of phrases by the user to satisfy privacy and control requirements.

The minimal requirements for a language set is that it provides for an intuitive set of phrases that link to a subject area known to the user and that it provides for enough linguistic variation to achieve the required security criteria. The minimal requirements for each controller generated phrase is that it is random, makes sense, constitutes a sample with good verification data, is simple to say and avoids inappropriate phrases.

The system generates phrases by applying the rules and knowledge of language to a database of words associated with language sets. Language sets should maintain a unique subset of words specific to the intuitive subject area but various language sets overlap i.e. sets are non-exclusive.

The system should vary controller determined phrase requests and randomly determine a phrase each time it authenticates a user for security purposes. Upon a fail or any other non-completion, the system will randomly determine a new phrase and not repeat the last phrase. Random generation of phrases is required; no pattern of phrases can exist. Such variance of phrases increases security because an imposter cannot anticipate random phrases.

Language sets provide a means for security and privacy management of users and user sets. For example, an organization or department can allow only one language set unique to that organization and then, if required, switch to another language set for control purposes. Or a user may elect to change their private phrases, not allow certain phrases/word or change language subsets should they believe their voice information has been compromised. Likewise an organization using the controller intelligence can disallow language sets, phrases and words for a user or group of users should there be a suspicion of theft or compromise.

These speech techniques demonstrate how users can intuitively control the use of their biometric for security purposes. Such techniques are far more flexible and intuitive than any available with a one-dimensional biometrics system such as a fingerprint. Contrary to conventional thinking, users will be relieved that their biometric may need to be refreshed after several years giving them the same control and freedom they have today to change their front door lock.

### Voice Architectural Implementation

The security scheme described above can theoretically be implemented across multiple systems and networks using voice systems such as digital cellular phones, Personal Digital Assistants (PDAs) and voice over Internet Protocol (VoIP) telephone systems and applications such as multi-media or voice portals on the Internet. The scheme is effective and applicable today in a speech communications environment particularly where high quality voice processing is prevalent. For example, a Personal Computer (PC) running voice recognition software with a sound card and noise canceling microphone headset installed. Therefore, the application discusses an overall security architecture and applies it to a system implementation architecture that will realize optimal security performance using voice processing.

The proposed network implementation of the voice security system is based on a Security System for Speech Communications architecture, which utilizes the power and control of a master processor for security and database functions, the quality of voice processors at intelligent remote units such as desktop and the most appropriate encryption method(s). The system describes a method to secure communication between a host computer at a host location such as an ISP and at least one terminal at a remote location, said method comprising the steps of generating a digital signal at said remote location corresponding to an orally generated speech pattern of a prospective user; storing said digital signal in a first memory device; compressing said signal to a compressed signal, optionally digitally signing said compressed signal; encrypting said compressed signal; receiving said encrypted compressed signal at said host location; optionally verifying digital signature of compressed signal; decrypting said encrypted compressed signal at said host location to form a usable compressed signal; comparing said usable compressed signal with said stored signal at said host location to permit access to the host computer in response to said usable compressed signal matching with said stored signal. The architecture accommodates multiple methods of sending and receiving authentication information such as methods of streaming in a VoIP environment, etc.

The authentication process begins when a remoter user requests access, for example to their AOL accounts and services. During the initial user request for access, the user makes a claim that represents who they are. The claim information could be through a keyboard input of a PIN, speech input of PIN or other identification information such as an account number, identification of the cell phone ID provided by cell phone provider or any other method that facilitates the users initial claim as to who they are. Said claim information could be digitally signed and/or encrypted. The main controller validates initial user claim information and performs random generation of a challenge phrase as described herein and optionally associated encryption and/or digital signature keys to be used to protect authentication information described herein across the network. A user can also be requested to speak a phrase determined by the user.

As shown in FIG. 3, the proposed security system comprises at least one user terminal and a controller gateway function, which determines access, based on matching results. The gateway performs management and control functions associated with matching or recognition, enrollment, random phrases, language sets, database security and encryption. Such a controller could be associated with single sign on systems to further the power and reach of the authentication process.

The main controller has the resources to perform such tasks as specifying required security levels and balancing of both verification and recognition modeling and matching to obtain the desired accuracy levels. The n-dimensional system can interface with other security technologies such as single sign on systems, magnetic card systems or others that make sense to bundle depending on application and security needs.

### Quality Voice Processing

During enrollment and speaker or speech recognition, it is essential that the speaker and speech’ recognizer consist of a high quality acoustic channel and speaker decoder so that voice processing meets the high security requirements of today's world. The security architecture proposed lends itself to such. The voice solution stipulates quality voice input, signal processing, modeling and matching throughout all voice processing whereby each is essential and intrinsically linked for good performance [5]. One should not assume based on prior designs that all voice processing must be done either all at a desktop or all over-the-telephone line from any phone because any component of voice processing can be done anywhere between the user and controller as long as the desired results are obtained. To obtain the quality security results stated above, the proposed implementation architecture processes voice input, signal processing and performs compression or modeling at the user terminal and models and matches at the controller.

A good deal of sound and speech technology today is oriented toward telephone speech and widely used telephone systems. Thus, voice processing often assumes a narrow bandwidth and noisy channel prevalent with telephone speech. A voice verification system that performs a voice test from any telephone handset over any telephone line is greatly different from a voice verification system where a voice test from a PC via a microphone making use of CD quality sound processing. Any telephone connected to the telephone system is widely available but a more intelligent device such as a PC system, PDA or intelligent phone has the capability of processing voice far more accurately as we already understand from many years of use with voice recognition technology, for example, large vocabulary speech to text applications that are performed solely at the desktop with a headset and not over a telephone line.

For example, a standard PC sound card or motherboard sound samples voice input at CD quality (a rate of 44 kilohertz). Sound is transmitted as input through 2 channels that carry 16 bits or 2 byte words per channel, for a total of 4 bytes. Therefore the CD rate of 44,000 samples per second utilizing 4 byte resolution and assuming linear coding of the data represents 1 megabyte of voice data per 6 seconds. PC Pentium processors can easily support statistical algorithms that handle up to 1 megabyte of data. This potential capability is greater than the normal processing for telephone speech, however, which samples at 8 kilohertz and uses 8 bits data with logarithmic scaling that represents less than 48 k of voice data per 6 seconds.

### Summary

Protection from unauthorized users has brought forth the development of biometric security systems but users are cautious due to fears associated with biometrics. Contrary to current thinking, biometric security systems that use dynamic biometrics, i.e. ones that can more easily vary such as voice, have the potential to be highly secure and private through an n-dimensional security scheme architecture, which tightly couples such a biometric with human input. Advancements described herein include the implementation of speaker recognition technology in a data communications environment, which is greatly more accurate than past implementations using telephony types of voice processing constrained by narrow and noisy acoustic channels. Also, the new combination of existing real-time natural language processing and speaker recognition technologies is practical in today's information systems environment to achieve n-dimensional security. The benefits of robust security techniques and intuitive privacy schemes inherent in an n-dimensional security system is extremely important in today's world of data communications and information systems.

### References

[1] Gregory Tuai, Security System for Data Communications. U.S. Pat. No. 5,153,918, 1992

[2] Micki Krause and Harold F. Tipton, Handbook of Information Security Management 1999, CRC Press,

[3] Qi Li, Biing-Hwang Juang, Chin-Hui Lee, Qiru Zhou, and Frank K. Soong, Recent Advancements in Automatic Speaker Authentication. IEEE Robotics & Automation Magazine. March 1999

[4] David Crystal, Cambridge Encyclopedia of Language. Cambridge University Press. 1987.

[5] Jelinek, Frederick. Statistical Methods for Speech Recognition, The MIT Press, Cambridge, Mass., 1997

What is claimed is:

1. A N-dimensional biometric security system comprising
a station for receiving input information from a user representative of the user and generating a responsive signal thereto;
a first data base having a plurality of words and language rules for generating one-time challenge phrases corresponding to the user and a session access request therein;
a second data base having biometric models of the users therein; and
a controller to receive and validate said signal as representative of the user, said controller communicating with said first data base for delivering a randomly generated challenge phrase at said station for the user to speak in response to validation of said signal, and said controller communicating with said station to receive and validate a spoken response to said selected challenge phrase as representative of the user.

2. A method of identifying and validating a user comprising the steps of
having a user initially input information representative of the user at a station;
generating a signal responsive to the information;
receiving and validating the signal as representative of the user;
thereafter delivering a randomly generated challenge phrase at said station for the user to speak in response to validation of said signal;
having said user speak the randomly generated challenge phrase and generating a second signal representative of the spoken response to said challenge phrase; and
thereafter receiving and validating the second signal as representative of the user.
